(19) United States
(12) Patent Application Publication
(10) Pub. No.: US 2002/0005949 A1
(43) Pub. Date: Jan. 17, 2002

(54) Spectroscopic analyzer and process utilizing light intensity spatial distribution information

(76) Inventor: Takeshi Uemura, Minami-ku (JP)

Correspondence Address: PRICE AND GESS, 2100 S.E. Main St., Suite 250, Irvine, CA, 92614, US

(21) Appl. No.: 09/883,743

(22) Filed: Jun. 18, 2001

(30) Foreign Application Priority Data
Jun. 23, 2000 (JP) 2000-189862

(51) Int. Cl. G01J 3/20; G01N 21/73

(52) U.S. Cl. 356/316; 356/328

(57) ABSTRACT

A spectroscopic analyzing apparatus and process can increase the signal to noise ratio by executing an optimal spectroscopic analysis of light from a light source. The light source can provide different light spectrum intensities representative of an element at different temperatures across the light source. An optical system can form a two-dimensional image of the light source on a photo sensor for providing a plurality of output signals representative of the desired measurement areas for a particular component. Information representative of the various components can be prestored so that a computer can select the optimum pixel positions from the sensor to process the output signals in making a determination of a component while only using those output signals from the sensor that can optimize the signal to noise ratio.

### BACKGROUND OF THE INVENTION

1. Field of the Invention

The present invention relates to a spectroscopic analyzing apparatus that can be incorporated within analyzers which spectroscopically analyze emitted light having various distribution intensities depending upon the component to be measured, and more particularly, a spectroscopic analyzing system and method which can record and analyze a two-dimensional image of the light and process the corresponding array of output signals across the light image to determine the presence of specific components.

2. Description of the Prior Art Various forms of analyzers have been utilized such as an inductively coupled plasma analyzer which quantitatively analyzes the amount of an element to be measured from a sample specimen by using a light emission spectrometer and a glow discharge spectrometer which can analyze light to determine various intensity distributions depending on the component to be measured.

FIG. 6 is a schematic diagram of a conventional spectrometer 20 which can comprise an essential measuring arrangement of an inductively coupled plasma analyzer (hereinafter referred to as “ICP”). A plasma generating torch unit 21 can incinerate a sample specimen inserted into a plasma torch 21a. A conventional lens 22 can condense the light emitted from a specific region of the plasma torch 21a so that it is incident on a slit opening 24 positioned on a Rowland circle 23. A diffraction grating 25, which has a curvature identical and complimentary to that of the Rowland circle 23, can reflect the condensed light onto a series of slits 26a through 26d appropriately positioned on the Rowland circle 23 for passing light having a specific wavelength which has been dispersed by the diffraction grating 25. Appropriate sensors 26a to 27d are positioned behind the respective slits 26a to 26d for sensing the strength of light that is passed through the respective slits. Examples of such a sensor can be a photo-multiplier tube and a photo-sensing semiconductor.

In operation, the grating 25 has a convex surface of a curvature identical to that of the Rowland circle 23 so that incident light that is passed through the slit 24 is condensed and focused on one of the slits 26a to 26d, whereupon the light passing through these slits then enters into their appropriate sensors 27a to 27d. The position of each the slits 26a to 26d is determined by the respective wavelengths of light that is desired to be measured. Each of the elements contained in a sample specimen which is subject to combustion within the plasma torch 21a emits a characteristic peak wavelength of light that is inherent to a specific element to be measured. The ICP analyzer in the prior art comprises the plurality of sensors 27a to 27d which are arranged according to the position of the slits 26a to 26d. Each of the sensors sense independently a light component associated with a different element to be measured within the sample. Some of the ICP analyzers in the prior art have utilized a sensor which can be scanned by a sequence controller so that the sensor moves in the diffraction direction of the diffraction grating 25. As a result, the sensor can execute a quantitative analysis of a plurality of elements in the sample to be measured.

The temperature of the plasma torch 21a can vary from 6,000K to 10,000K along its vertical direction as shown in FIG. 7. Correspondingly, the temperature of the sample specimen which is introduced into the plasma torch 21a from a lower position will change according to its passage through the plasma torch 21a. As a result, the relative position of the sample in the plasma torch, where each of the elements are to be measured and emit light, can differ across the torch configuration even when an identical plasma torch 21a is used.

An additional issue is that there can be a difference in both the wavelength and in the strength of light emitted from an element to be measured according to whether the element is in the state of an ion or in the state of a neutral atom. The position in the torch, which gives the maximum of a ratio of the light amount from the element to that of the noise light (i.e., the maximum signal to noise ratio), depends on the type of element to be measured.

FIG. 8 is a graph showing the value of BEC as a function of the height of the plasma torch 21a in a spectroscopic analyzer 20 of the prior art for a variety of different elements. The value of BEC is the ratio of the intensity of the noise to that of the emitted light. FIG. 8 discloses that the maximum SN ratio, which corresponds to the minimum BEC value with respect to Zn, is obtained at a height of 13 mm in the plasma torch 21a. The corresponding maximum SN height with respect to Mn is at a height of 17 mm. Therefore, when the vertical position of the plasma torch 21a is changed according to the element to be measured, it is possible to obtain the maximum SN ratio for each of the elements. When Zn, for example, is selected as one of the most important components to be measured, it is possible to adjust the vertical position of the plasma torch 21a to a height of 13 mm. Conversely, it is also possible to determine the vertical position of the plasma torch 21a to a height of 17 mm, for example, which will give an acceptable SN ratio with respect to all of the relevant elements to be analyzed by the analyzer 20. It is also possible to move the plasma torch 21a in the vertical direction to obtain an optimum SN ratio for each of the elements to be measured when a plurality of elements are being measured.

The spectroscopic analyzer 20 of the prior art, however, suffers a drawback in that setting the position of a plasma torch 21a, for example, to a height of 13mm to provide the maximum light output for the distribution of Zn as shown in FIG. 7, will necessarily deteriorate the signal to noise ratio with regards to the other elements such as V, Ti, Mn, Mg, and Ca.

On the other hand, when the vertical position of the plasma torch 21 is set to a position of a height of 17 mm which can give an acceptable signal to noise ratio for all of the elements, the SN ratio for some of the elements will deteriorate excessively. Additionally, when an operator must move the plasma torch 21a in the vertical direction while a measurement is executed, photometry for each position of the plasma torch 21a would then be necessary. Therefore, the measuring time would be substantially increased adding to the cost and possible inaccuracies in a measuring mode of operation.

Thus, the prior art is still seeking to optimize the ability to provide a spectroscopic analyzing process and apparatus.

### SUMMARY OF THE INVENTION

An object of the present invention is to propose a spectroscopic analyzing apparatus and process, which can increase the SN ratio, by executing an optimal spectroscopic analysis of light from a light source, for example, light emitted from ICP. Such a light source gives different light spectrum inherent to the element to be measured and has a different light strength distribution according to the light emitting position in the light source.

The spectroscopic analyzing apparatus according to the present invention comprises a light source, which can provide different light spectrum inherent to the component to be measured from an incinerated sample and has a different strength distribution according to a light emitting position within the light source; a spectroscope for dispersing the wavelength of the light from the light source; a CTD photo sensor for sensing light having a specific wavelength dispersed by the spectroscope; and an optical system for providing an image of the light source on the CTD photo sensor.

A CTD (Charge Transfer Device) sensor can transfer charges for each clock pulse, which is set at a suitable sequence. Using this basic function, video imaging, data storing, signal treatment or other logical treatment can be executed. A representative CTD is a CCD (Charge Coupled Device). In a CCD photo-sensing device, a number of micro pixels, each of which is comprised of a micro semiconductor photo sensing device, are arranged in an array on a focal plane.

When a spectrum of light is analyzed, from a light source which gives different light spectrum inherent to the components to be measured and has a different strength distribution according to the light emitting position therein, pixels giving the maximum SN ratio can be selected from a plurality of predetermined pixels in the CTD photo-sensing device for each of the components to be measured and the light intensity sensed by those selected pixels is employed for quantitative analysis.

In determining the measuring condition of an ICP spectroscopic analysis, the optimal measuring position in the plasma torch where the maximum SN ratio is given, will be different for each of the components to be measured. However, physical displacement of the plasma-generating torch by an operator is not necessary in the present invention. A portion of emitted light, which gives the maximum SN ratio, can be selected for each component to be measured. It is also possible to execute the spectroscopic analysis at the optimal measuring position for each of the components, simultaneously. Correspondingly, a higher level of quantitative analysis can be attained.

Accordingly, adjustment of the plasma flame position by a user for improving the SN ratio is not needed. Thus, the user can obtain a SN ratio inherent to the analyzer as a matter of routine, namely, he or she can always analyze at the maximum limit of detection preciseness.

In an embodiment of the present invention, the spectroscopic analyzing apparatus further comprises an excitation unit for exciting a sample to emit light characteristic of components contained within the sample; an optical system for imaging the light into a two dimensional image; a two dimensional sensor assembly for receiving the two dimensional image and providing a plurality of output signals representative of pixel positions in the receiving image; a memory for storing the light intensity spatial distribution information, which is the information about intensity spatial distribution of light emitted from a predetermined quantity of each component to be measured; and an operational portion for calculating the content of the components to be measured, on the basis of the values in the stored light portion indicated by the light intensity spatial distribution information, among the values which are measured by the CTD sensor and possess intensity spatial distribution.

In this embodiment, the SN ratio can be improved by using the light intensity spatial distribution information stored in the memory and the measurement preciseness can be improved. The light intensity spatial distribution information which has been stored in the memory, is the intensity distribution actually measured, using a predetermined quantity of an actual component to be measured at various locations across the image of the light. Thus, even if the intensity distribution depends only a little on the form of the light source, a maximum SN ratio measurement can be attained.

### BRIEF DESCRIPTION OF THE DRAWINGS

The exact nature of this invention will be readily apparent from consideration of the following detailed description in conjunction with the accompanying drawings, wherein:

FIG. 1 is a schematic perspective view of an example of spectroscopic analyzing apparatus according to the present invention;

FIG. 2 shows examples of intensity distribution of light emitted from a plasma flame;

FIG. 3 shows an image of a plasma torch formed on a CCD photo-sensing device in the case that the measurement is executed in the transverse direction;

FIG. 4 shows examples of measuring portion in the CCD photo-sensing device, which differ according to the content to be measured;

FIG. 5 shows an image of a plasma flame formed a CCD photo-sensing device in the case that the measurement is executed in the longitudinal direction;

FIG. 6 is a schematic diagram of a spectroscopic analyzing apparatus in the prior art;

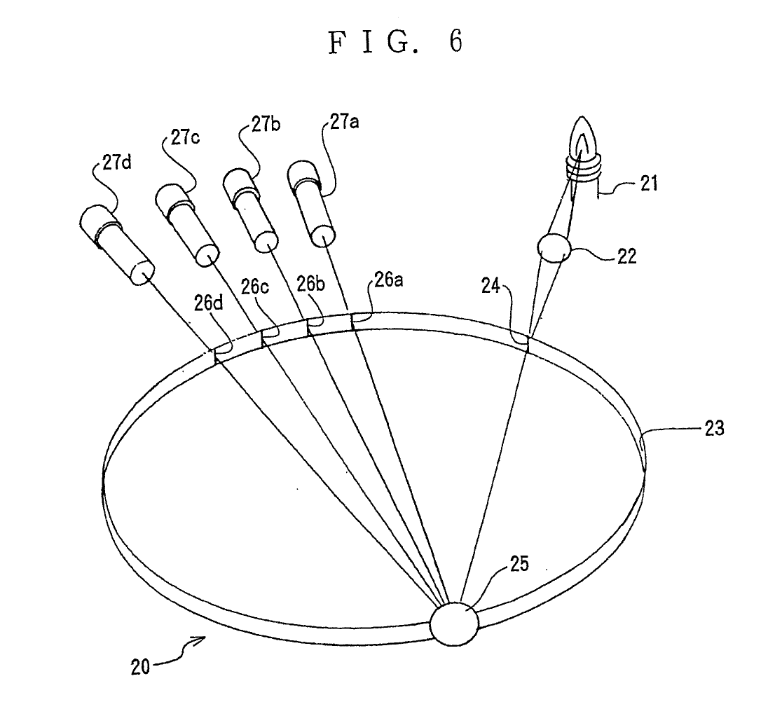

FIG. 7 is an example of the temperature distribution in a plasma flame;

FIG. 8 is a graph showing an analysis preciseness as a function of the measuring height of the plasma flame; and

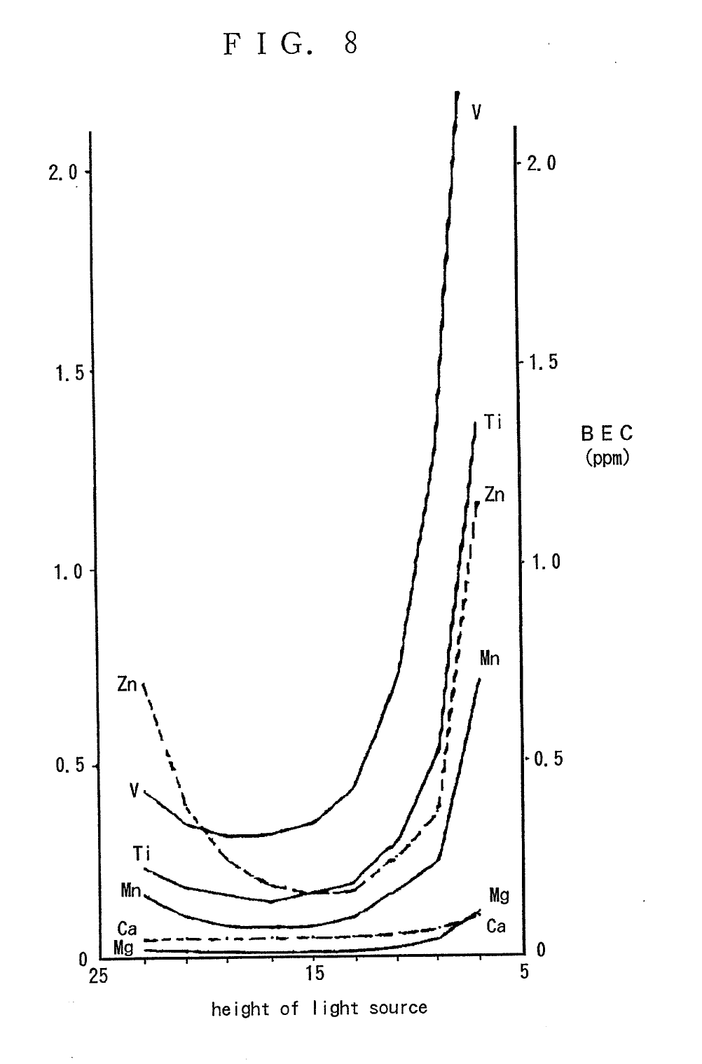

FIG. 9 is a flow chart of the process of the present invention.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein to specifically provide a spectroscope analyzer and process utilizing light intensity spatial distribution information.

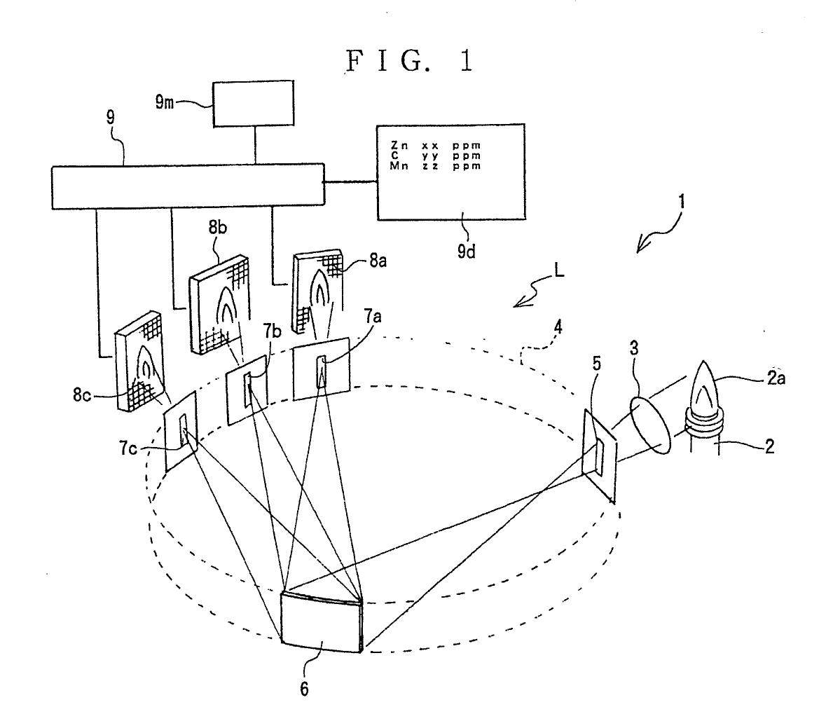

FIG. 1 is an example of a spectroscopic analyzing apparatus 1 according to the present invention, which is applied to an ICP of a multi-purpose type. In FIG. 1, reference numeral 2 denotes a plasma-generating torch. A sample specimen will emit light in the plasma flame 2a of the plasma-generating torch 2 as it is combusted. A condenser lens 3 condenses light emitted from a substantial portion of the plasma flame 2a. An inlet slit 5 is disposed on a Rowland circle 4 for passing the light condensed by the lens 3. A diffraction grating 6 has a curvature identical to that of the Rowland circle 4. The diffraction grating is only one example of a type of spectroscope. Additionally, a glow discharge spectroscope can also be used in the present invention. It is also possible to use other forms of excitation units than a torch to combust the sample when the excitation unit provides different temperatures at discrete locations for generating the emitted light.

Reference numerals 7a to 7c denote outlet slits disposed on the Rowland circle 4 for passing the light having specific wavelengths dispersed by the diffraction grating 6. Reference numerals 8a to 8c denote CCD (Charge Coupled Device) photo-sensing devices for sensing light passing through one of the outlet slits 7a to 7c. In this example, a polychromatic optical system L is formed by the inlet slits 5, diffraction grating 6, and outlet slits 7a to 7c, which are arranged on an identical Rowland circle 4.

Because the optical system L is polychromatic, the incident light passed through the inlet slit 5 is dispersed to individual wavelengths by a diffraction grating 6, and simultaneously the dispersed lights are respectively condensed on one of the outlet slits 7a to 7c. Namely, they are arranged so that a two dimensional image of the plasma flame 2a is formed on each of the CCD photo-sensing devices 8a to 8c, which are disposed correspondingly behind each of the outlet slits 7a to 7c.

Each of the CCD photo-sensing devices 8a to 8c is comprised of a plurality of pixels, which are arranged in a two-dimensional array to form a focal plane. An image of the light from the light source, i.e., plasma flame 2a, is formed on the CCD photo-sensing devices 8a to 8c. Therefore, the spatial distribution of the light intensity can be measured, by measuring the intensity of the sensed light at each of the pixel locations. Therefor, it is possible to measure the light emission intensity at each position in the plasma flame 2a to provide a corresponding source of light data responsive to an address of each pixel location.

Reference numeral 9 denotes a microcomputer, which is an example of an operational portion. The microcomputer 9 is connected to each of the CCD photosensing devices 8a to 8c. The microcomputer 9 includes a memory 9m for storing the light intensity distribution data information, which is information of the spatial distribution of light emitted from the specific components to be measured. The microcomputer 9 further includes a display 9d. The microcomputer 9 is connected to the photo-sensing devices 8a to 8c and the light intensity sensed by each of the CCD photo-sensing devices 8a to 8c is inputted to the microcomputer 9. The microcomputer 9 can calculate the content of the components to be measured using a program that can process the light intensity distribution, which is optimal for the measurement of each of the specific components to be measured. The light intensity distribution is selected from the stored light intensity distribution information. Thus, an analyzer unit for processing the plurality of light output signals from the pixel positions can determine the presence of specific elements or components in the sample.

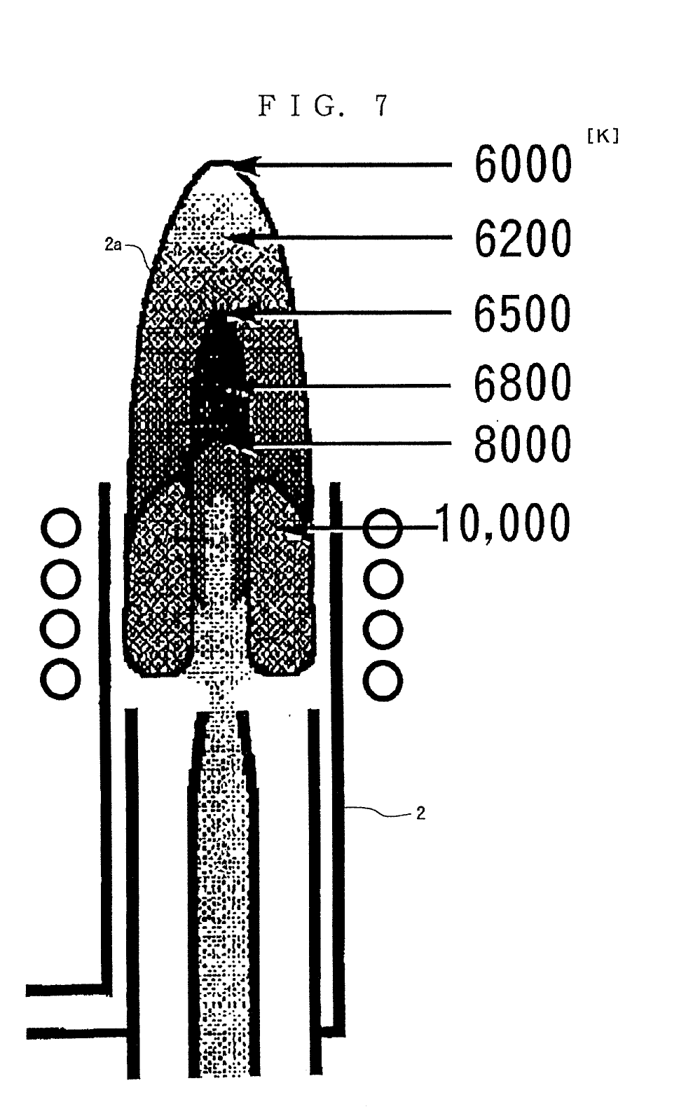

As described hereinbefore, there is a distribution of temperatures in the plasma flame 2a, which is illustrated in FIG. 7. As a result, the light-emitting position of each of the components to be measured in a plasma flame 2a may differ from each other. Moreover, the intensity and frequency of light is dependent upon whether the light is emitted from the component to be analyzed in an ion state or in a neutral atom state. Therefore, a position, where the ratio of the light amount from the component to be measured to that of the environmental noise (SN ratio) is the maximum, can differ according to the kind of the components to be measured.

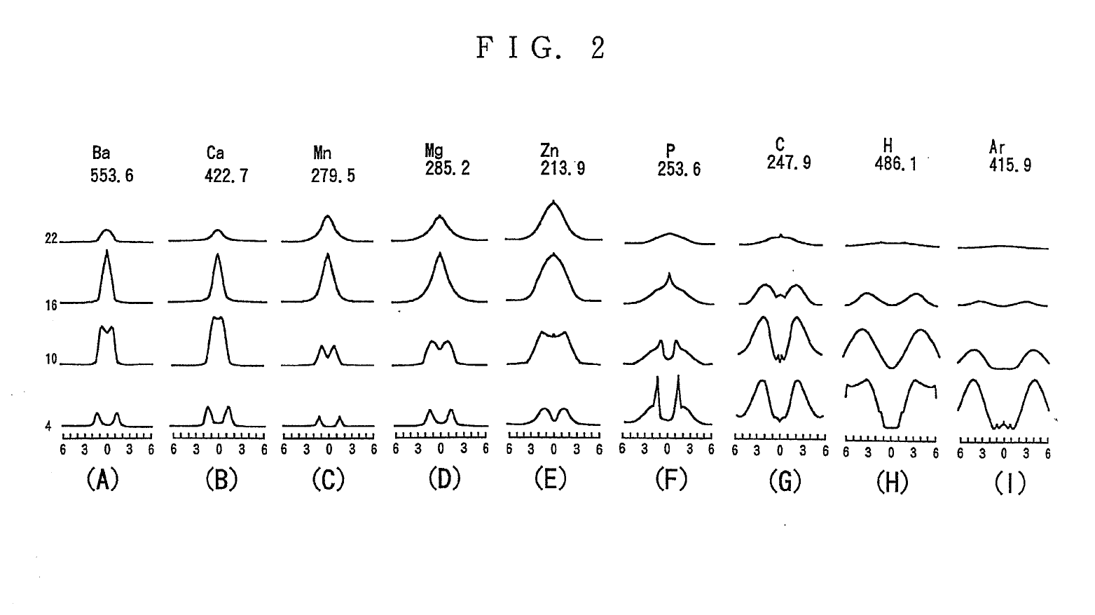

FIGS. 2(A) to 2(I) show intensity distributions of light emission by a representative sample of element. Note, the present invention is not limited to these illustrative samples since it is known that each element can provide a discrete characteristic wavelength. FIGS. 2(A) to 2(I) show intensity distributions of light emitted from different elements such as Ba, Ca, Mn, Mg, Zn, P, C, H and Ar. The number disclosed under each of the chemical symbols indicates the wavelength of light to be emitted from each of the elements.

FIGS. 2(A) to 2(I) illustrate graphs showing four light intensity distribution at positions in a plasma torch 2, which are at heights of 4 mm, 10 mm, 16 mm and 22 mm measured from the upper end of the plasma generating torch 2 and shown on the ordinate. Namely, the graphs show four light intensity distributions at different heights in the longitudinal direction of the plasma flame 2a. The abscissa of each of the graphs indicates the transverse position in the plasma flame 2a. In the graphs, the light intensity distribution for each of the specific elements is shown in a two-dimensional range within 6 mm in the left and right sides from the center of the plasma torch 2.

As illustrated in FIGS. 2(A) to 2(I), the position where each of the specific components emit light strongly is different from each other. For example, as to Ba, Mn, Mg and Zn, the maximum intensity in the height direction is obtained at a height of about 16 mm from the top of the plasma generating torch 2 (where an exiting high frequency coil is disposed on the plasma generating torch 2). And as to C, H and the like, a high intensity light can be obtained at a height of about 10 mm in the height direction. With respect to the peripheral direction of the plasma torch, the elements Ba, Ca, Mn, Mg, Zn and P give a high intensity at a portion relatively near to the center of the plasma flame. And C, H and Ar give the maximum intensity at a position separated from the center by 3 to 5 mm.

At the start of loading each sample having a component to be measured in the plasma light emission spectroscopic analyzing apparatus 1 according to the present invention, the temperature is increased so that a specific pre-determined component to be measured emits light in the plasma flame 2a. CCD photo-sensing devices (any of the CCD photo-sensing devices 8a to 8b) sense the light. Each of the COD photo-sensing devices senses a corresponding pre-determined wavelength of light. The measured value is clocked from the sensor unit to be inputted to a memory in the microcomputer unit 9. Namely, a spatial distribution of a two-dimensional array of light intensity in the plasma light emission spectroscopic analyzing apparatus 1 is measured, and the information is stored in the memory 9m as light intensity distribution data information. On the basis of this light intensity distribution data information, pixels in the CCD photo-sensing devices 8a to 8c at discrete addresses are selected, which will be used in the quantitative analysis of an unknown sample specimen to be measured.

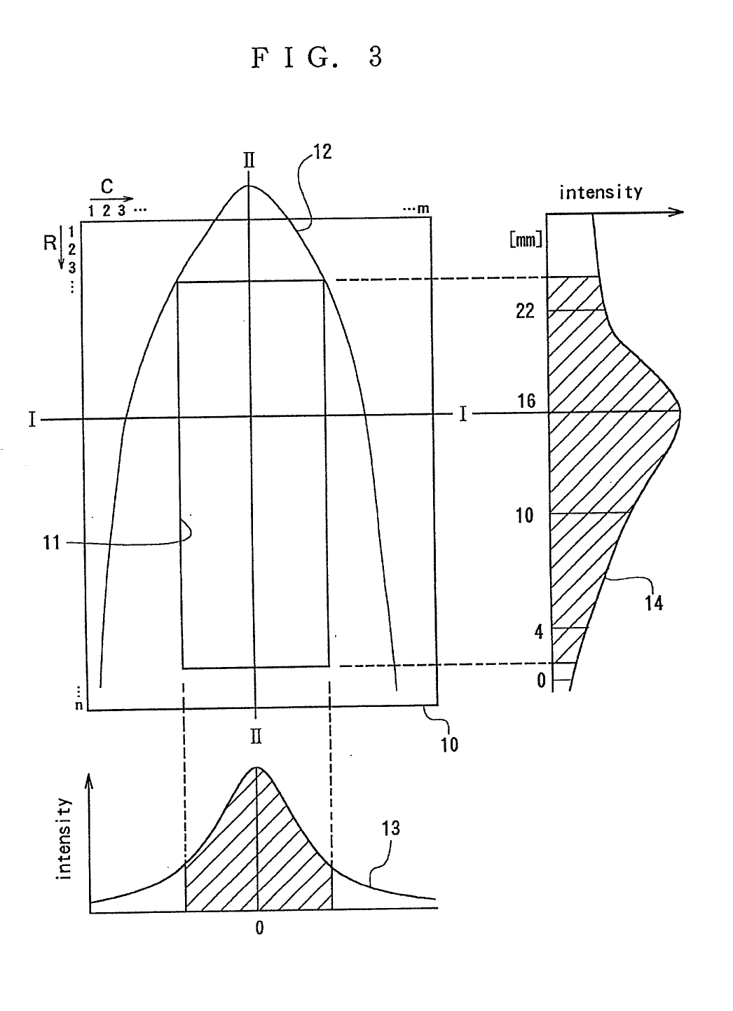

FIG. 3 is a diagram schematically showing the light intensity distribution information with respect to the light emitted from Mn, as an example, heated in a plasma flame 2a. The light is emitted from the side surface of the plasma torch, namely, a transverse photometry is executed in this case. In FIG. 3, reference numeral 10 denotes a photo-sensing surface of the COD photo-sensing devices 8a to 8e, 11 is a range of light passed through the slit 7a to 7c, 12 is an image of the plasma flame 2a formed on the photo-sensing surface 10.

Reference numeral 13 denotes a light intensity curve sensed by pixels disposed on a transverse line I-I drawn in the photo-sensing surface 10, where an image is formed. Reference numeral 14 denotes a light intensity curve sensed by pixels disposed on a longitudinal line II-II drawn in the photo-sensing surface 10.

It can be determined from FIG. 3 that, as to the measurement of Mn, the maximum light intensity can be obtained at a position in a central portion at a region of height of 16 mm in the photo-sensing surface 10 of the CCD photo-sensing devices 8a to 8c. The light intensity distribution data information is stored in the memory 9m of the microcomputer 9. The pixels, which sense the highest intensity light, are calculated from the light intensity distribution information, and are specified by an address of a row number R (1 to n) and a column number C (1 to m). The output of the specified pixels is used in the photometry.

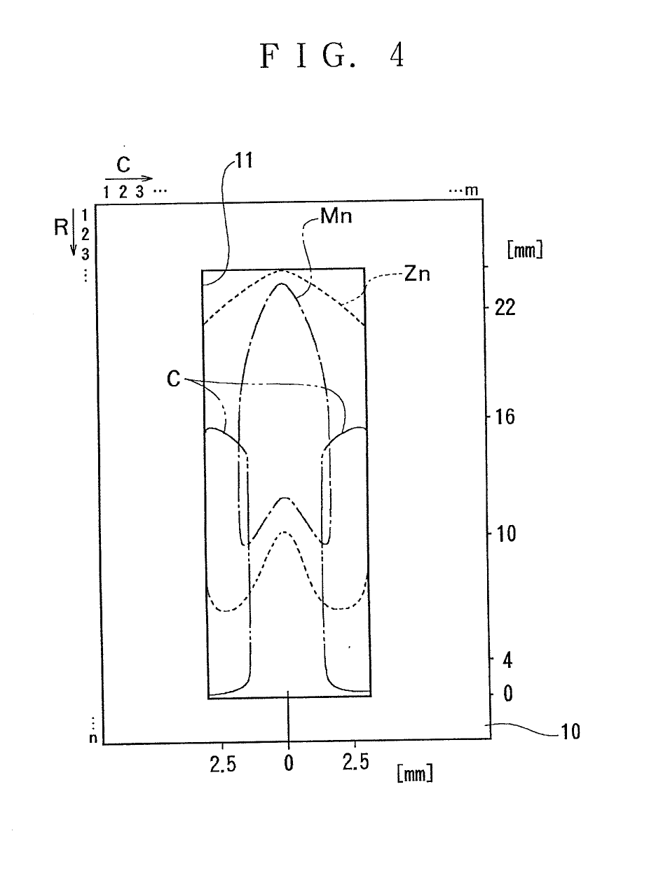

FIG. 4 shows that the sensing region differs according to the specific elements to be measured. The region indicated by a one-point-dotted line in FIG. 4 is the sensing region for Mn, which is described referring to FIG. 3. Namely, the sensing region extends substantially in the central portion in the width direction, and in a region centered at a height of 16 mm in the height direction.

The region indicated by a two-point dotted line shows the sensing region for C. The region extends in the region of 2.5 mm on both side regions in the width direction, and in a region centered at a height of 10 mm in the height direction. Namely the region extends along both the right and left sides. The region indicated by a broken line shows the sensing region for Zn. The region includes the sensing region for Mn. The region extends in the substantially central region in the width direction, and in a region centered at a height of 16 mm in the height direction.

These sensing regions are determined, according to the intensity distribution of light emitted from each of the specific components, which will be determined by referring to the intensity distribution of light emission illustrated in FIG. 2. Namely, pixels, which give a good SN ratio for each of the specific components to be measured, can be selected to match these light patterns. In other words, the region where the intensity of light emitted from a component to be measured is weak can be excluded. Thus the entering of error due to the noise other than the light from the component to be measured into the true measured value is prevented.

Users are not required to adjust the vertical position of the plasma torch 2, as previously executed in the prior art so as to increase the measurement preciseness. Namely, laborious works for the measurement can be decreased. Users can select a measurement region, which gives the maximum preciseness, irrespective of the kind of components to be measured, and he or she can implement the analysis using the selected measurement region. Namely, an analysis at a maximum preciseness can be executed as a matter of routine.

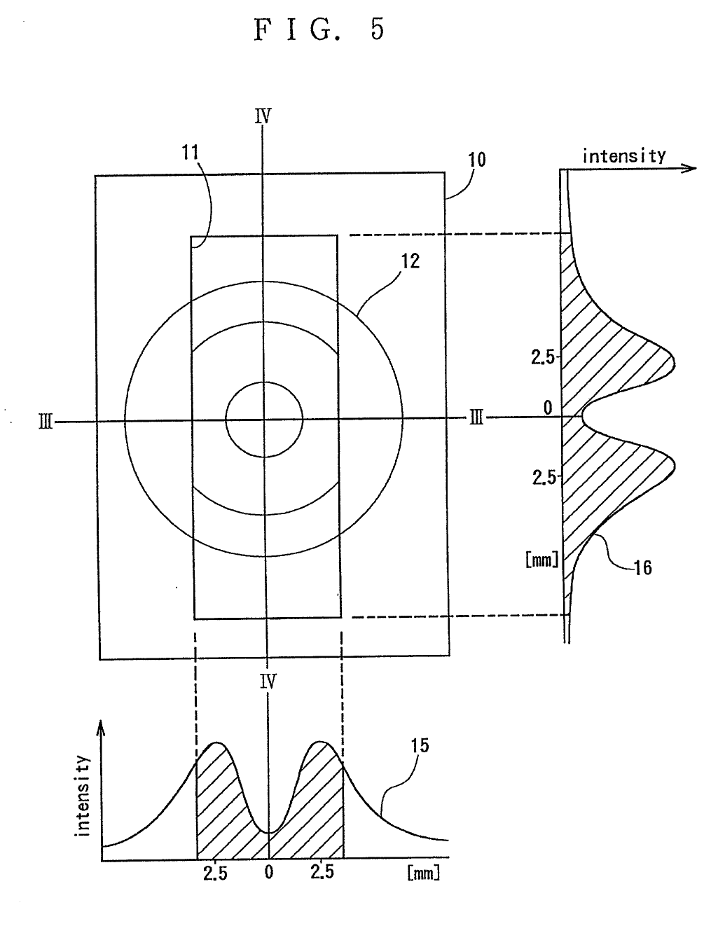

FIG. 5 is a diagram schematically showing the light intensity distribution information with respect to the light emitted from C heated in a plasma flame 2a. The light is emitted from the top of the plasma torch, namely, a longitudinal photometry is executed in this case. In FIG. 5, reference numeral 15 denotes a light intensity curve sensed by pixels, which are disposed on a transverse line III-III drawn in the photosensing surface 10 for sensing light illuminated onto this line in the image formed on the surface 10. Reference numeral 16 denotes a light intensity curve sensed by pixels disposed on a longitudinal line IV-IV drawn in the photo-sensing surface 10.

As illustrated in FIG. 5, carbon C has a high intensity region, where the intensity of the light emission is high, formed into a circular portion around the center of the plasma flame 2a at a distance of 2.5 mm from the center. Therefore, when a longitudinal photometry is executed for carbon C, information from pixels, which are disposed in a circular band around the center and having a radius of 2.5 mm, are extracted from the pixels in the photo-sensing plane 10 of the CCD photo-sensing devices 8a to 8c. Each of the selected pixels is specified by a row number R (1 to n) and a column number C (1 to m). The outputs of those pixels are used in the photometry.

The spectroscopic analyzing apparatus 1 according to the present invention comprises an optical system L, as described hereinbefore, referring to FIGS. 3 to 5. The optical system L comprises one lens 3 disposed in front of the first slit 5. When the light passes through the first slit, it enters into the diffraction grating 6, the grating disperses the light, according to the wavelength. The dispersed light is condensed on the outlet slits 7a to 7c provided in accordance with the wavelength on the Rowland circle 4, and an image 12 of a substantial portion of the plasma flame 2a is formed on the photo-sensing plane 10 of the photo-sensing devices 8a to Be by the optical system L. By selecting a measuring region in the CCD photo-sensing devices 8a to 8e corresponding to each of the components to be measured, a high preciseness analysis can be attained.

As to the size of the image 12 formed on the photo-sensing plane 10 of the CCD photo-sensing devices 8a to 8c, it is not required to contain the border area of the plasma flame 2a However, it is necessary to contain the image of a substantial part of the plasma flame 2a that provides the valuable light intensity information. Namely, the lens 3, the dimensions of the inlet slit 5, the diffraction grating 6 and the outlet slits 7a to 7c should be designed so that an image of the larger part of the plasma flame 2a is formed on the photo-sensing plane 10 of the CCD photo-sensing devices 8a to 8c.

The embodiment of FIG. 1 discloses an example for measuring simultaneously three components to be measured, using three outlet slits 7a to 7c and three CCD photo-sensing devices 8a to 8c, which are previously disposed for each of the components to be measured. The three positions correspond to the wavelength dispersion by the diffraction grating 6. However, the scope of the present invention is not limited to this example. It is possible to use four or more or two or less outlet slits and a corresponding number of photo-sensing devices. It is also possible to dispose one outlet slit 7 and one CCD photo-sensing device 8 on the Rowland circle 4 so that they can rotate along the Rowland circle. By rotating them, a desired quantitative analysis of the components can be attained.

This embodiment further discloses an example applied to an atomic emission spectroscopy, in which atoms are heated by means of a plasma flame 2a so as to emit light. However, the present invention is not limited to this embodiment. Namely, the light source can be the light source used in GDS analyzer or other excitation unit. In other words, when the spectroscopic analyzing apparatus 1 according to the present invention is used, it is possible to use any light source, in which light having different wavelengths are generated according to the components and depending on the position therein. Even when such a light source is used, the measurement preciseness can be improved as best as possible.

The spectroscopic analyzing apparatus of the present invention can be calibrated with unique stored data representative of a light intensity distribution pattern for a particular flame image for a predetermined quantity of known elements at different temperatures across the profile of the flame image. The flame image is standardized and the user will calibrate the instrument with a standard sample. Note, the optimum flame position will vary according to the sample condition. For example, whether the sample contains a large volume of water vapor. Thus, the user will permit the standard sample to acquire a condition close to the desired sample before calibration and subsequent measuring of the sample.

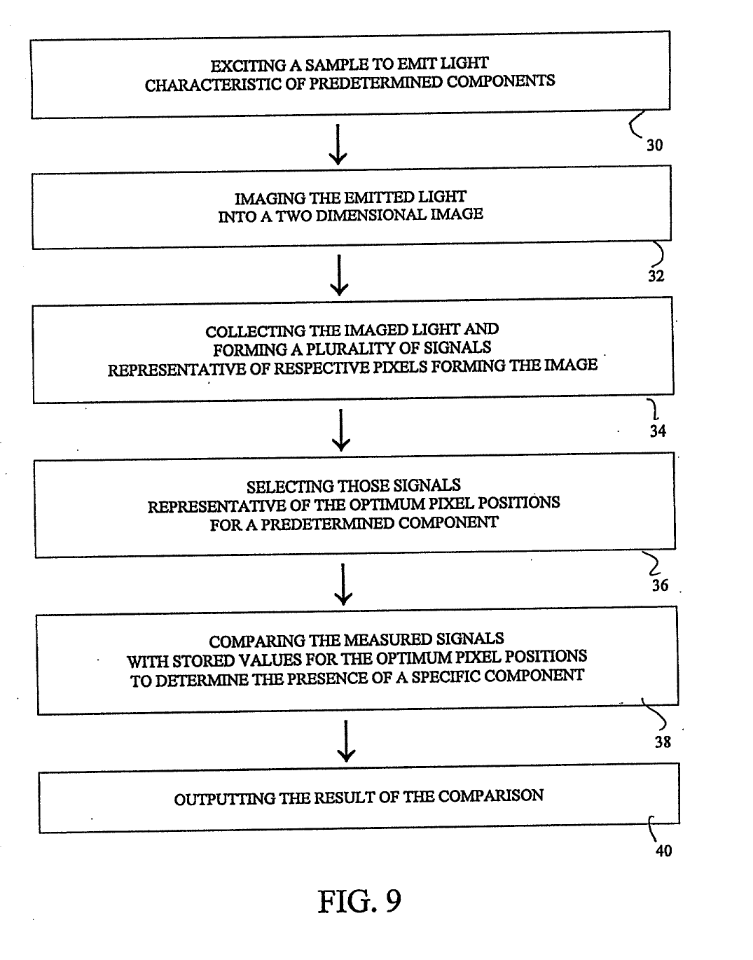

After the calibration, the user will excite in step 30 a sample to emit light characteristic of the predetermined components as shown in FIG. 9. The optical system of a condenser lens, entrance slit, diffraction grating, and exit slits, will image the emitted light into a two-dimensional image in step 32 on each of the respective sensors. The sensors will collect the imaged light at their respective wavelengths to form a two-dimensional matrix of output signals representative of respective pixel locations forming the image on each sensor in step 34. By referring to the stored data representative of predetermined elements at predetermined temperatures, it is possible to select those output signals representative of the optimum pixel positions in step 36 for a particular component. A comparison of the measured signals with the stored data permits a determination of the presence of a specific component in step 38. The results can be displayed or printed in step 40.

As described hereinbefore, when the spectroscopic analyzing apparatus according to the present invention is used, it is possible to execute a photometry of light from a light source, in which light having different wavelengths according to the component to be measured and depending on the position therein are generated. In the photometry, pixels are selected from the pixels in the CCD photo-sensing devices so that each of them senses light corresponding to a specific component to be measured at the maximum SN ratio. The light intensity obtained by those selected pixels is used for the quantitative analysis. Thus, according to the present invention, it is possible to select light coming from a position in the light source, which gives the maximum SN ratio, for each of the components to be measured.

Each of the components to be measured can be analyzed at an optimal measuring position, therefore, a higher preciseness quantitative analysis is possible. Position adjustment of the plasma flame by the user for improving the SN ratio is no longer required. The SN ratio inherent to the analysis can be obtained as a matter of routine. It is possible to execute a measurement at an upper limit of sensing precision.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A spectroscopic analyzing apparatus comprising:
a light source, which provides a light spectrum inherent to a component to be measured and has a different strength distribution for the component according to a light emitting position in the light source;
a spectroscope for dispersing a wavelength of the light from the light source;
an optical system for forming an image of the light source; and
a CTD photo sensor unit for sensing the image of the light source having a specific wavelength dispersed by the spectroscope to provide output signals representative of a two-dimensional image of the light.

2. The spectroscopic analyzing apparatus according to claim 1, further comprising: a memory for storing light intensity spatial distribution information, which is information about intensity spatial distribution of light emitted from a predetermined quantity of each component to be measured; and an operational portion for calculating the content of the components to be measured, on the basis of values in the stored light intensity spatial distribution information and the output signals measured by the CTD sensor and processing corresponding light intensity spatial distribution data representative of the component.

3. The spectroscopic analyzing apparatus according to claim 2, wherein said optical system is polychromatic and a plurality of CTD photo-sensing devices are disposed corresponding to outlet slits, each of which corresponds to a specific wavelength, disposed on a Rowland circle, each of the CTD photo-sensing devices sensing only light having a corresponding wavelength as dispersed by the spectroscope whereby a plurality of components can be identified.

4. The spectroscopic analyzing apparatus according to claim 3, wherein said light source is a plasma torch having a plasma flame, in which a sample specimen, introduced into the plasma flame, emits light.

5. An apparatus for determining components in a sample comprising:
an excitation unit for exciting a sample to emit light characteristic of components contained within the sample;
an optical system for imaging the light into a two-dimensional image;
a two-dimensional sensor assembly for receiving the two-dimensional image and providing a plurality of output signals representative of pixel positions in the two-dimensional image;
a memory for storing optimum pixel positions for predetermined components; and
an analyzer unit for processing the plurality of output signals representative of the stored optimum pixel positions to determine the presence of a specific component.

6. The apparatus of claim 5 wherein the excitation unit is a plasma torch for providing a flame.

7. The apparatus of claim 5 wherein the memory stores data representative of a light intensity distribution pattern for a flame image of a predetermined quantity of known elements at different temperatures across the flame image.

8. The apparatus of claim 5 wherein the two-dimensional sensor assembly has an array of pixel positions for providing corresponding outputs at each pixel positions.

9. The apparatus of claim 8 wherein the excitation unit is a plasma torch for providing a flame.

10. The apparatus of claim 9 wherein the memory stores data representative of a light intensity distribution pattern for a flame image of a predetermined quantity of known elements at different temperatures across the flame image.

11. A process for determining components in a sample comprising the steps of:
exciting a sample to emit light characteristic of components contained within the sample;
imaging the light into a two-dimensional image;
providing a plurality of output signals representative of pixel positions in the two-dimensional image;
storing optimum pixel positions for predetermined components; and
processing the plurality of output signals representative of the stored optimum pixel positions to determine the presence of a specific component.

12. The process of claim 11 wherein the optimum pixel positions represent predetermined light intensity signals for a predetermined component at a predetermined excitation temperature.
